(19) United States
(12) Patent Application Publication
(10) Pub. No.: US 2014/0313090 A1
(43) Pub. Date: Oct. 23, 2014

(54) LENS WITH MIXED-ORDER CAUER/ELLIPTIC FREQUENCY SELECTIVE SURFACE

(71) Applicant: Samsung Electronics Co., Ltd., Suwon-si (KR)

(72) Inventors: Jungsuek Oh, Fairview, TX (US); George Zohn Hutcheson, Richardson, TX (US); Wonbin Hong, Seoul (KR)

(73) Assignee: Samsung Electronics Co., Ltd., Suwon-si (KR)

(21) Appl. No.: 14/196,714

(22) Filed: Mar. 4, 2014

Related U.S. Application Data
(60) Provisional application No. 61/814,149, filed on Apr. 19, 2013.

(51) Int. Cl. H01Q 19/09; H01Q 15/08

(52) U.S. Cl. CPC H01Q 19/09; H01Q 15/08
USPC 343/753; 343/911 R

(57) ABSTRACT

An apparatus includes a lens having a plurality of layers of conductive elements and a plurality of layers of dielectric. Each of the layers of dielectric is disposed between and in contact with two of the layers of conductive elements. Different layers of conductive elements can include different numbers of conductive elements. The layers of conductive elements and the layers of dielectric can form a Cauer/Elliptic frequency selective surface. The lens could include only three layers of conductive elements and only two layers of dielectric, where the lens is a mixed-order frequency selective surface with a middle layer of conductive elements having fewer conductive elements than outer layers of conductive elements. A size of the conductive elements in at least one of the layers of conductive elements could vary as distance from a center of the lens increases.

### CROSS-REFERENCE TO RELATED APPLICATION(S) AND CLAIM OF PRIORITY

The present application claims priority under 35 U.S.C. §119(e) to U.S. Provisional Patent Application Ser. No. 61/814,149 filed Apr. 19, 2013 and entitled “LOW-COST LOW-LOSS PLANAR LENS EMPLOYING MIXED-ORDER CAUER/ELLIPTIC FILTER.” The above-identified provisional patent application is hereby incorporated by reference in its entirety.

### TECHNICAL FIELD

The present application relates generally to wireless communication systems and more specifically to the use of a lens in electromagnetic (EM) wave transmissions.

### BACKGROUND

A lens is an electronic device that can focus a planar wave front of EM waves to a focal point or, conversely, collimate spherical waves emitting from a point source to plane waves. Such fundamental characteristics are widely used in various applications, such as communication, imaging, radar, and spatial power combining systems. For example, in millimeter-wave frequency bands that fifth generation (5G) communication standards may employ, lenses have been paid considerable attention as a potential solution to overcome limits in gain and beam steering capabilities of antennas operating in such frequency bands.

### SUMMARY

Embodiments of this disclosure provide lenses with frequency selective surfaces and related systems and methods.

In one example embodiment, an apparatus includes a lens having a plurality of layers of conductive elements and a plurality of layers of dielectric. Each of the layers of dielectric is disposed between and in contact with two of the layers of conductive elements.

In another example embodiment, a method includes transmitting an electromagnetic wave through a lens having a plurality of layers of conductive elements and a plurality of layers of dielectric. Each of the layers of dielectric is disposed between and in contact with two of the layers of conductive elements.

In yet another example embodiment, a system includes a lens, a transmitter or transceiver configured to generate signals for wireless transmission, and an antenna configured to transmit electromagnetics wave through the lens based on the signals. The lens includes a plurality of layers of conductive elements and a plurality of layers of dielectric. Each of the layers of dielectric is disposed between and in contact with two of the layers of conductive elements.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example wireless system that transmits messages in accordance with this disclosure;

FIG. 2 illustrates an example transmit path in accordance with this disclosure;

FIG. 3 illustrates an example receive path in accordance with this disclosure;

FIG. 4 illustrates an example planar frequency selective surface (FSS) lens in accordance with this disclosure;

FIG. 5 illustrates an example difference in phase shift of a mixed-order FSS lens in accordance with this disclosure;

FIG. 6 illustrates an example exploded view of the topology of a Cauer/Elliptic FSS (CEFSS) lens in accordance with this disclosure;

FIG. 7 illustrates an example equivalent circuit model of the CEFSS lens illustrated in FIG. 6 in accordance with this disclosure;

FIG. 8 illustrates example magnitude and phase plots of transmittance of a third-order Cauer/Elliptic filter in accordance with this disclosure;

FIG. 9 illustrates an example exploded view of a topology of a mixed-order CEFSS lens in accordance with this disclosure;

FIGS. 10A and 10B illustrate example magnitude and phase plots of transmittance of the mixed-order CEFSS lens illustrated in FIG. 9 in accordance with this disclosure;

FIG. 11 illustrates example zones of a mixed-order CEFSS lens in accordance with this disclosure;

FIG. 12 illustrates an example spatial phase shift profile of the mixed-order CEFSS lens of this disclosure;

FIG. 13 illustrates an example three-dimensional simulation of electromagnetic wave propagation through the mixed-order CEFSS lens in accordance with this disclosure; and

FIG. 14 illustrates an example plot of wave power gain versus angle of propagation for electromagnetic waves in accordance with this disclosure.

### DETAILED DESCRIPTION

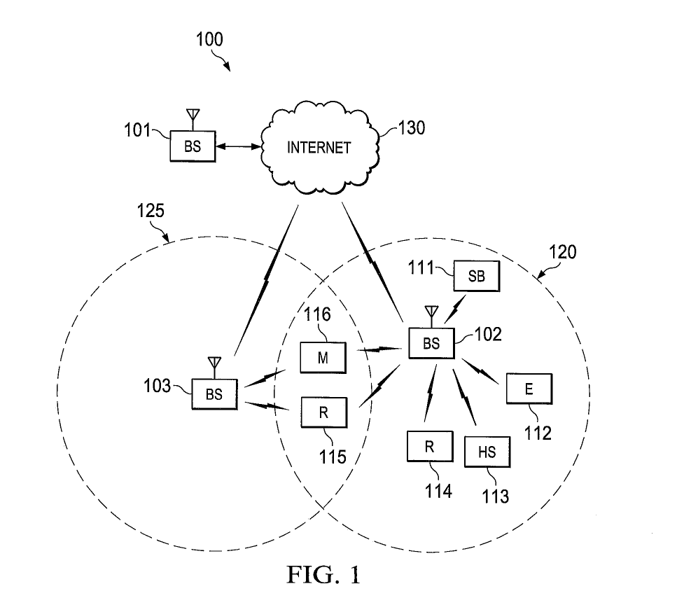

FIGS. 1 through 14, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably-arranged system or device.

Various figures described below may be implemented in wireless communication systems, possibly including those that use orthogonal frequency division multiplexing (OFDM) or orthogonal frequency division multiple access (OFDMA) communication techniques. However, the descriptions of these figures are not meant to imply physical or architectural limitations in the manner in which different embodiments may be implemented. Different embodiments of this disclosure may be implemented in any suitably-arranged communication systems using any suitable communication techniques.

FIG. 1 illustrates an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes an eNodeB (eNB) 101, an eNB 102, and an eNB 103. The eNB 101 communicates with the eNB 102 and the eNB 103. The eNB 101 also communicates with at least one Internet Protocol (IP) network 130, such as the Internet, a proprietary IP network, or other data network.

The eNB 102 provides wireless broadband access to the network 130 for a first plurality of user equipments (UEs) within a coverage area 120 of the eNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The eNB 103 provides wireless broadband access to the network 130 for a second plurality of UEs within a coverage area 125 of the eNB 103. The second plurality of UEs includes the UE 115 and the UE 116. In some embodiments, one or more of the eNBs 101-103 may communicate with each other and with the UEs 111-116 using 5G, LTE, LTE-A, WiMAX, WiFi, or other wireless communication techniques.

Depending on the network type, other well-known terms may be used instead of “eNodeB” or “eNB,” such as “base station” or “access point.” For the sake of convenience, the terms “eNodeB” and “eNB” are used in this patent document to refer to network infrastructure components that provide wireless access to remote terminals. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an eNB, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with eNBs, such as the coverage areas 120 and 125, may have other shapes, including irregular shapes, depending upon the configuration of the eNBs and variations in the radio environment associated with natural and man-made obstructions.

As described in more detail below, the eNBs 101-103 and/or the UEs 111-116 could include one or more Cauer/Elliptic frequency selective surface (FSS) lenses.

Although FIG. 1 illustrates one example of a wireless network 100, various changes may be made to FIG. 1. For example, the wireless network 100 could include any number of eNBs and any number of UEs in any suitable arrangement. Also, the eNB 101 could communicate directly with any number of UEs and provide those UEs with wireless broadband access to the network 130. Similarly, each eNB 102-103 could communicate directly with the network 130 and provide UEs with direct wireless broadband access to the network 130. Further, the eNB 101, 102, and/or 103 could provide access to other or additional external networks, such as external telephone networks or other types of data networks.

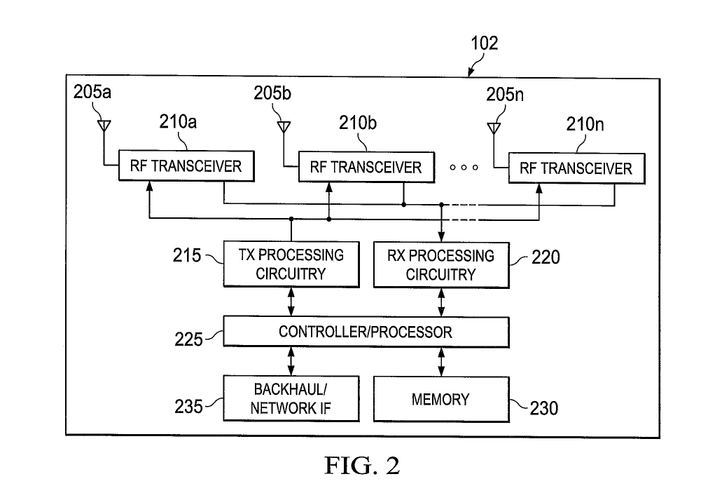

FIG. 2 illustrates an example eNB 102 according to this disclosure. The embodiment of the eNB 102 illustrated in FIG. 2 is for illustration only, and the eNBs 101 and 103 of FIG. 1 could have the same or similar configuration. However, eNBs come in a wide variety of configurations, and FIG. 2 does not limit the scope of this disclosure to any particular implementation of an eNB.

As shown in FIG. 2, the eNB 102 includes multiple antennas 205a-205n, multiple RF transceivers 210a-210n, transmit (TX) processing circuitry 215, and receive (RX) processing circuitry 220. The eNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the eNB 102. For example, the controller/processor 225 could control the reception of forward channel signals and the transmission of reverse channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. Any of a wide variety of other functions could be supported in the eNB 102 by the controller/processor 225. In some embodiments, the controller/processor 225 includes at least one microprocessor or microcontroller.

The controller/processor 225 is also capable of executing programs and other processes resident in the memory 230, such as a basic OS. The controller/processor 225 can move data into or out of the memory 230 as required by an executing process.

The controller/processor 225 is also coupled to the backhaul or network interface 235. The backhaul or network interface 235 allows the eNB 102 to communicate with other devices or systems over a backhaul connection or over a network. The interface 235 could support communications over any suitable wired or wireless connection(s). For example, when the eNB 102 is implemented as part of a cellular communication system (such as one supporting 5G, LTE, or LTE-A), the interface 235 could allow the eNB 102 to communicate with other eNBs over a wired or wireless backhaul connection. When the eNB 102 is implemented as an access point, the interface 235 could allow the eNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

As described in more detail below, the eNB 102 could include one or more Cauer/Elliptic FSS lenses.

Although FIG. 2 illustrates one example of eNB 102, various changes may be made to FIG. 2. For example, the eNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the eNB 102 could include multiple instances of each (such as one per RF transceiver). Also, various components in FIG. 2 could be combined, further subdivided, or omitted and additional components could be added according to particular needs.

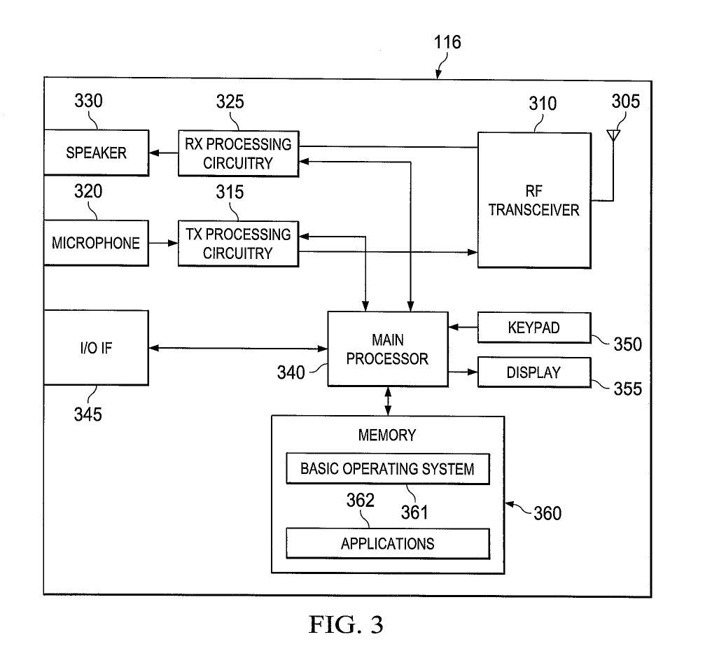

FIG. 3 illustrates an example UE 116 according to this disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by an eNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 could control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360. The main processor 340 can move data into or out of the memory 360 as required by an executing process. In some embodiments, the main processor 340 is configured to execute the applications 362 based on the OS program 361 or in response to signals received from eNBs or an operator. The main processor 340 is also coupled to the I/O interface 345, which provides the UE 116 with the ability to connect to other devices such as laptop computers and handheld computers. The I/O interface 345 is the communication path between these accessories and the main processor 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites.

The memory 360 is coupled to the main processor 340. Part of the memory 360 could include a random access memory (RAM), and another part of the memory 360 could include a Flash memory or other read-only memory (ROM).

As described in more detail below, the UE 116 could include one or more Cauer/Elliptic FSS lenses.

Although FIG. 3 illustrates one example of UE 116, various changes may be made to FIG. 3. For example, various components in FIG. 3 could be combined, further subdivided, or omitted and additional components could be added according to particular needs. As a particular example, the main processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

Embodiments of this disclosure recognize and take into account the fact that lenses may provide several significant improvements to antennas used in communication systems, including microwave and millimeter wave (MMW) communication systems. These improvements can include increased antenna directivity for specific point-to-point communications and improved link availability; increased antenna gains for better signal-to-noise ratios, data capacities, and link reliabilities; reduced antenna side-lobes for more effective use of antenna radiation patterns and for less interference from other radios; and reduced antenna losses for lower system power consumptions. Lenses provide these improvements while maintaining the capability of antenna pattern beam steering, which is useful in many microwave and MMW communication systems. Further, these enhancements can be realized using only passive structures to avoid the complexity and energy losses associated with approaches where active devices are used for such improvements.

Embodiments of this disclosure also recognize and take into account the fact that phase shifts realized by a frequency selective surface (FSS) can be used to design planar lenses. In these lenses, a wide range of phase shifts may be covered by tuning high-order bandpass FSSs. For example, cascading multiple first-order FSSs with a spacing of a quarter wavelength between each panel can increase the overall thickness of the FSS and enhance the sensitivity of the frequency response to the angle and polarization of incidence of EM waves. Advances in FSS technology also enable the synthesis of low-profile high-order bandpass FSSs that are composed entirely of non-resonant periodic structures. One type of FSS uses a pair of inductive and capacitive layers to increase one or more orders of the bandpass response. However, this stacked topology with multiple bonding layers constitutes a bottleneck for commercial MMW applications due to its high cost and to performance degradations caused by multiple bonding layers.

Embodiments of this disclosure further recognize and take into account the fact that certain planar lens technologies for microwave or MMW systems have critical drawbacks, which hamper their practical applications. These drawbacks can include the following:
bulk and size—to obtain phase changes for collimation or focusing, fully dielectric lenses are thick, bulky, and heavy;
feature sizes drawbacks—metal trace widths or gaps between metal traces on the order of a thousandth of a wavelength are difficult to be fabricated cost-effectively for lenses in the MMW band and much of the microwave bands; and
complexity—construction that involves multiple metal and dielectric layers, alternating metal layers of different and complicated layout designs, and bonding layers between dielectric layers having dielectric and electrical properties inconsistent with other dielectric layers increase cost, weight, and insertion losses of planar lenses.

Additionally, shortcomings in certain high-order bandpass FSS lenses may include the following:
high fabrication costs due to a large number of substrate, metal, and bonding layers;
high ohmic losses due to a large number of metallic traces;
high dielectric losses due to a large number of substrate and bonding layers;
poor fabrication tolerances due to mismatches in material properties between bonding layers and dielectric layers; and
limits in applying FSS lenses for high-frequency applications, such as 5 G communication systems, due to very fine feature sizes (such as the overall gaps between metal traces) being on the order of a thousandth of a wavelength.

Accordingly, various embodiments of this disclosure provide low-cost, low-loss, low-profile planar lenses. The lenses of this disclosure can be used in various ways, such as for gain/pattern enhancements of radiating elements (such as antennas) operating in wireless communication platforms like UEs and eNBs. Moreover, various embodiments of this disclosure provide thinner configurations of planar lenses to cover elements with a reduced loading complexity. Further, the lenses of various embodiments of this disclosure may enhance system gains at RF front ends without using active devices and thus improve signal-to-noise ratios (SNRs). In addition, the increase in the power level of a received signal may allow for a reduction of power consumption in the overall system and more reliable wireless connections. In various embodiments of this disclosure, planar lenses may employ a mixed-order Cauer/Elliptic filter response, which may allow for a reduction in the number of substrates and metal layers in the lenses while maintaining phase shift targets.

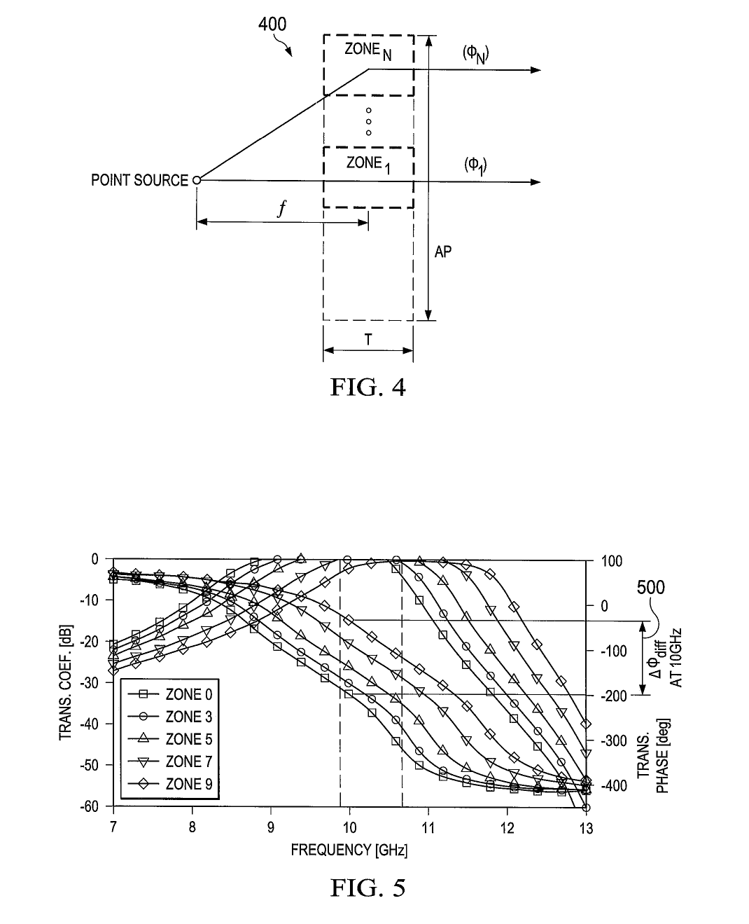

FIG. 4 illustrates an example planar FSS lens 400 in accordance with this disclosure. In this illustrative example, a phase shift is realized by the phase response of a FSS of the lens 400. An aperture of the lens 400 is split into multiple different zones (such as Zone1, Zone2, . . . , ZoneN). As depicted in FIG. 4, rays passing through the different zones of the FSS experience different amounts of phase shift. More specifically, the phase shift experienced by rays passing through the lens 400 decreases the further the rays are from the center of the lens 400, so there are higher phase shifts near the center of the lens 400 and lower phase shifts near the edges of the lens 400.

It may be necessary or desirable to reduce the focal length f of the lens 400 for compact wireless devices having small form factor demands, such as UEs. Reducing the focal length can involve maximizing the difference in phase shifts across the lens 400 (where Δφ_{diff}=|φ₁−φ_{N}|). The value of Δφ_{diff} is determined by the tunable range of the phase shift of FSS elements within the pass band of the FSS. The lens 400 may acquire the tunable range by modifying the sizes of the FSS elements slightly according to the number of zones.

FIG. 5 illustrates an example difference in phase shift of a mixed-order FSS lens in accordance with this disclosure. In this illustrative example, the difference in phase shift (Δφ_{diff}) 500 is about 160° within a 3 dB insertion loss (IL) bandwidth. Other design parameters for the lens 400 include the size of the lens aperture (AP), the thickness (t) of the lens 400, and the size of FSS unit cells. As the aperture size increases, the focusing gain increases, but the focal length f also increases when Δφ_{diff} is fixed. The lens thickness is related to the sensitivity of the lens 400 to the angle of incidence of EM waves. In addition, smaller FSS unit cells lead to finer focusing resolutions of the lens 400 but can require better tolerances of a fabrication process. The aforementioned design parameters in the lens 400 may be determined by considering the tradeoffs among performance, size, and fabrication conditions.

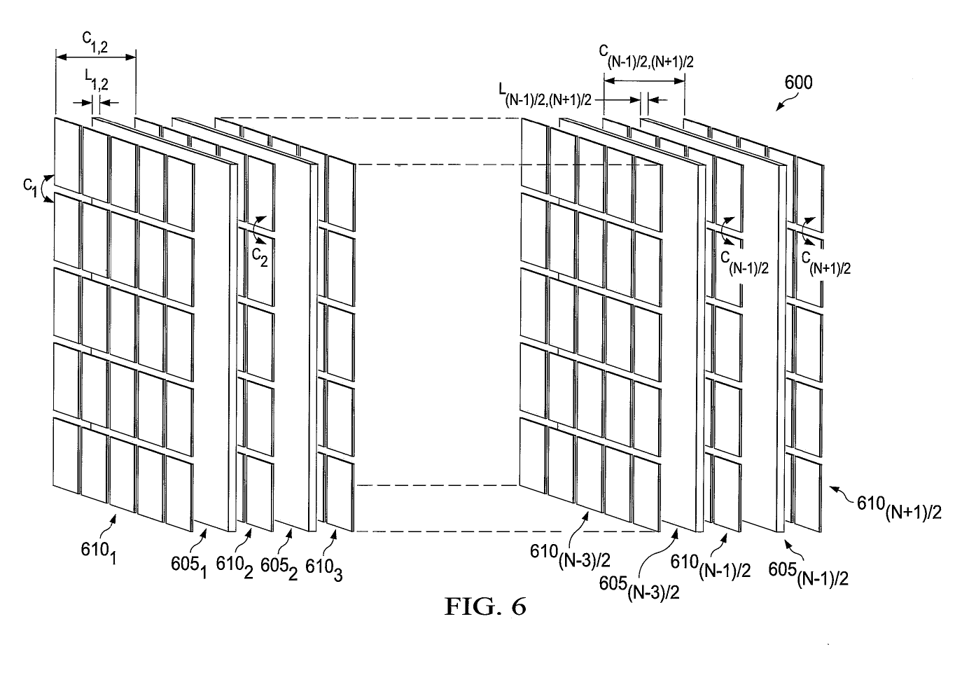

FIG. 6 illustrates an example exploded view of the topology of a Cauer/Elliptic FSS (CEFSS) lens 600 in accordance with this disclosure. In this illustrative example, the CEFSS lens 600 includes multiple dielectric substrate layers 605₁ to 605_{(N-1)/2} (referred to generally as dielectric substrate layers 605) and multiple metal patch element layers 610₁ to 610_{(N+1)/2} (referred to generally as metal patch element layers 610). Here, N is the order of the lens 600.

In this illustrative embodiment, the lens 600 includes metal patch element capacitive layers without any wire grid inductive layers. The metal patch element layers 610 are capacitive layers in that rays passing through the layers 610 experience impedance in the form of capacitance. An appropriate combination of different capacitance values C₁, C₂, . . . , C_{(N+1)/2} for the layers 610 provides a N^{th}-order Cauer/Elliptic filter response. The dielectric substrate layers 605 are inductive layers with inductance values L_{1,2}, L_{1,2}, . . . , L_{(N-1)/2,(N+1)/2}. The layers 605 are inductive in that rays passing through the layers 605 experience impedance in the form of inductance. Due to the thickness (or more precisely the thinness) of the dielectric substrate layers 605, electromagnetic coupling (specifically capacitive coupling C_{1,2} to C_{(N-1)/2,(N+1)/2}) is measurably present between the metal patch element layers 610 on opposite sides of one of the dielectric substrate layers 605.

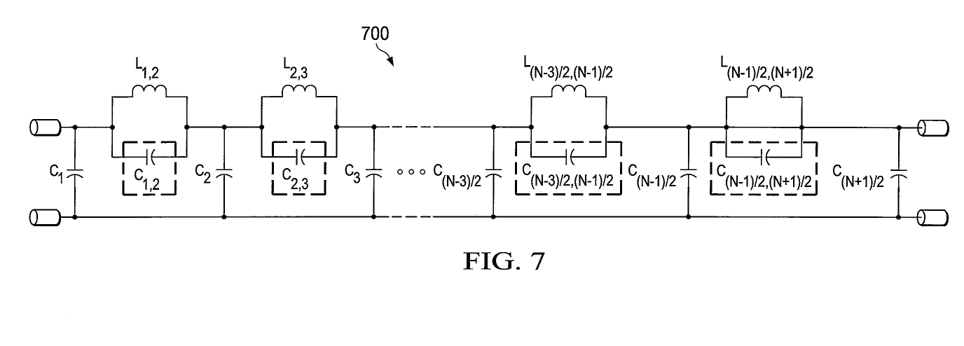

FIG. 7 illustrates an example equivalent circuit model 700 of the CEFSS lens 600 illustrated in FIG. 6 in accordance with this disclosure. In this illustrative example, the capacitance values C₁ to C_{(N+1)/2} are representative of the capacitance of the metal patch element layers 610₁ to 610_{(N+1)/2}, respectively. Also, the capacitance values C_{1,2} to C_{(N-1)/2,(N+1)/2} are representative of the capacitive coupling between adjacent pairs of the metal patch element layers 610₁ to 610_{(N+1)/2}, respectively. In addition, the inductive values L_{1,2} to L_{(N-1)/2,(N+1)/2} are representative of the inductance of the dielectric substrate layers 605₁ to 605_{(N-1)/2}, respectively.

As depicted by the equivalent circuit model 700, this disclosure utilizes capacitive coupling to reduce the size (such as the thickness) of the lens 600. Additionally, an appropriate manipulation of lumped elements in the equivalent circuit model 700 incorporating the capacitive couplings allows for the synthesis of high-order Cauer/Elliptic filters, which can achieve desired tunable ranges of phase shifts.

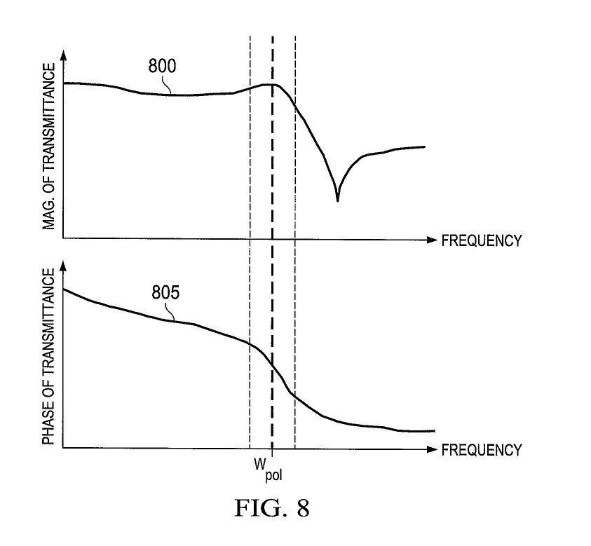

FIG. 8 illustrates example magnitude and phase plots of transmittance of a third-order Cauer/Elliptic filter in accordance with this disclosure. As illustrated by a magnitude plot 800 and a phase plot 805, transmittance of a third-order Cauer/Elliptic filter has a sharp variation in phase near the frequency of a transmission pole (wₚₒₗ). Around the transmission pole, a wide tuning range of phase shifts occurs. Accordingly, embodiments of this disclosure utilize wₚₒₗ as the operating frequency for the CEFSS lens 600. Therefore, lowering wₚₒₗ is, in effect, equivalent to reducing the size of the CEFSS lens 600. In a third-order Cauer/Elliptic filter, wₚₒₗ may be calculated according to Equation (1) as follows:

$${w}_{pol} = \sqrt{\frac{2 {Z}_{0}^{2} {C}_{1} - {L}_{1 , 2}}{{Z}_{0}^{2} {L}_{1 , 2} {C}_{1} ( {C}_{1} + 2 {C}_{1 , 2} )}} where {C}_{1} = {C}_{2} ( symmetry network ) \qquad [ 1 ]$$

According to Equation (1), as C_{1,2} (the capacitive coupling between metal path layers) increases, wₚₒₗ decreases. As a result, the lens 600 is able to achieve a range of phase shifts while reducing the thickness of the lens. In addition, the presence of this capacitive coupling between metal layers can mitigate fabrication difficulties resulting from small gaps between patch elements in the same plane. Depending on the particular application, the capacitive coupling can provide control of the size of FSS unit cells for either higher lens focusing resolution or better feature size for fabrication.

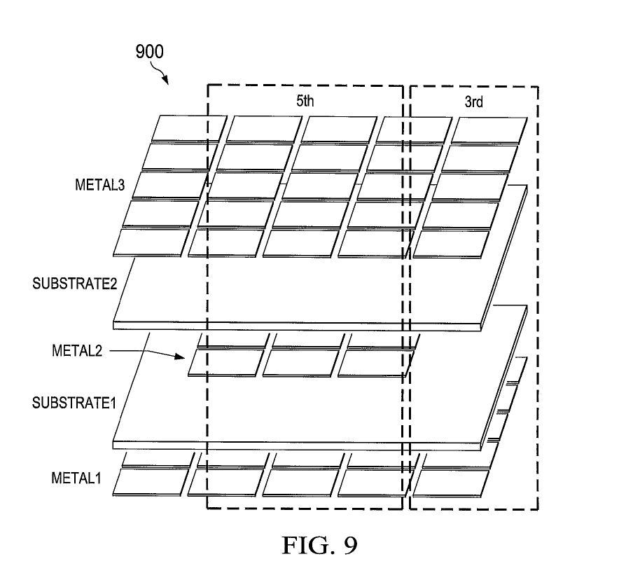

FIG. 9 illustrates an example exploded view of a topology of a mixed-order CEFSS lens 900 in accordance with this disclosure. The straight-forward geometry of this structure, including patch elements and dielectric layers, allows for the realization of a mixed-order CEFSS lens. In various embodiments, the lens 900 may include only patch elements and dielectric layers without any wire grid inductive elements.

As illustrated, the lens 900 has a mixed-order topology that, in this example embodiment, is a combination of third- and fifth-order Cauer/Elliptic filter networks. The fifth-order CEFSS unit cells are near the center of the lens 900 and include three metal layers, while the third-order CEFSS unit cells are near the edges of the lens 900 and include two metal layers. This mixed-order configuration enhances the tunable range of phase shifts of the lens 900 without increasing the order of the filter response.

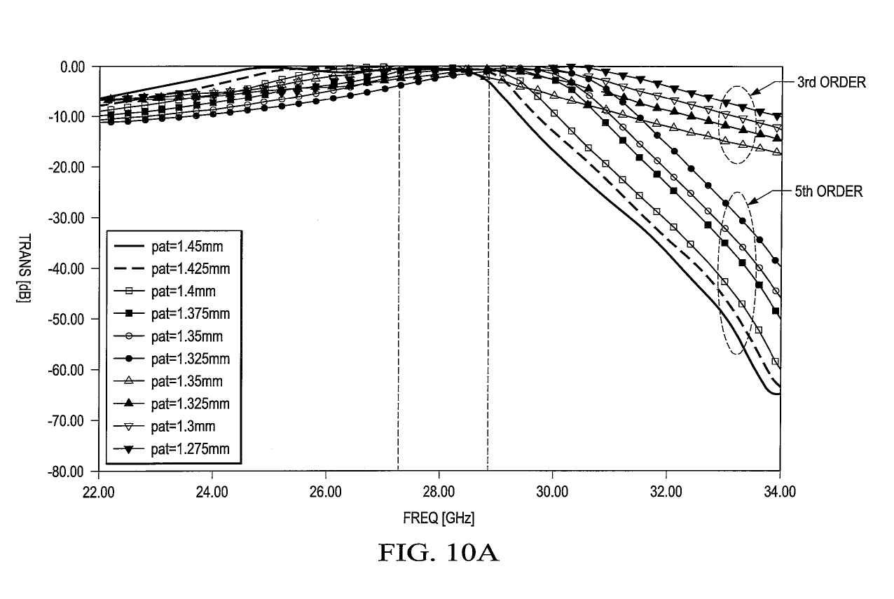

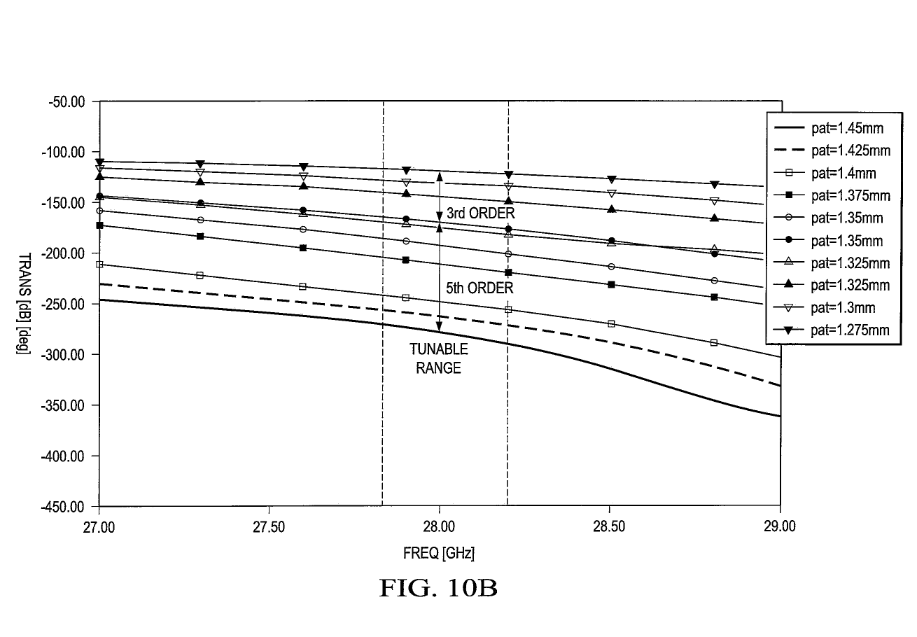

FIGS. 10A and 10B illustrate example magnitude and phase plots of transmittance of the mixed-order CEFSS lens 900 illustrated in FIG. 9 in accordance with this disclosure. In particular, FIGS. 10A and 10B illustrate (from EM simulations) the magnitude (FIG. 10A) and phase (FIG. 10B) of transmittance of the unit cells of the mixed-order CEFSS lens 900 designed with an operating frequency (wₚₒₗ) of 28 GHz.

In this illustrative example, the size of the unit cell is 1.6 mm, and the dielectric constant and thickness of the substrates are 10.2 and 0.25 mm, respectively. In the fifth-order region, the patch size in the middle layer (denoted by ‘Metal2’ in FIG. 9) is fixed at 1.5 mm. The patch size of the conductive patch elements in the top and bottom metal layers can be tuned from 1.325 mm to 1.45 mm with a step size of 0.025 mm. In the third-order region, the patch size of the conductive patch elements in the bottom and top metal layers can be tuned from 1.275 mm to 1.35 mm by the same step size. The dimensions described above are examples only and are not limitations on different dimensions that may be utilized in accordance with embodiments of this disclosure. For example, the sizes of the conductive patch elements in any of the layers may be increased or decreased based on various factors, such as phase shifts, lens thicknesses, and/or machining tolerances.

As depicted in FIG. 10B, the different order of the CEFSS elements can cover different ranges of phase shifts. This leads to an increase in the tunable range of the phase shift (such as Δφ_{diff}). In this example, the tunable range of the mixed-order CEFSS lens employing three metal layers and two substrate layers is about 160°, which may be comparable to existing design goals and/or attainable ranges of existing lenses employing much larger numbers of metal and substrate layers. Accordingly, the mixed-order CEFSS lens 900 can achieve desired goals of attaining suitable phase shift tunable ranges while reducing the size, thickness, and/or machining limitations of existing lens.

While in this example the lens 900 includes third- and fifth-order Cauer/Elliptic filter networks, any number of layers (and consequently any number of the order of the filters) may be utilized in accordance with this disclosure. For example, based on the desired tunable range of the phase shift, more than two different orders of filter responses may be utilized. In another example, larger or fewer metal and substrate layers may be used.

Depending on the implementation, advantages of using a mixed-order CEFSS lens of this disclosure may include:
lower fabrication costs due to smaller numbers of substrate, metal, and bonding layers;
lower ohmic losses due to smaller numbers of metallic traces;
simpler geometries being fabricated;
lower dielectric losses due to smaller numbers of substrate and bonding layers; and
improved feature sizes due to dependence on not only in-plane capacitances between patch elements on the same layer but also additional capacitances between patch elements in different metal layers.

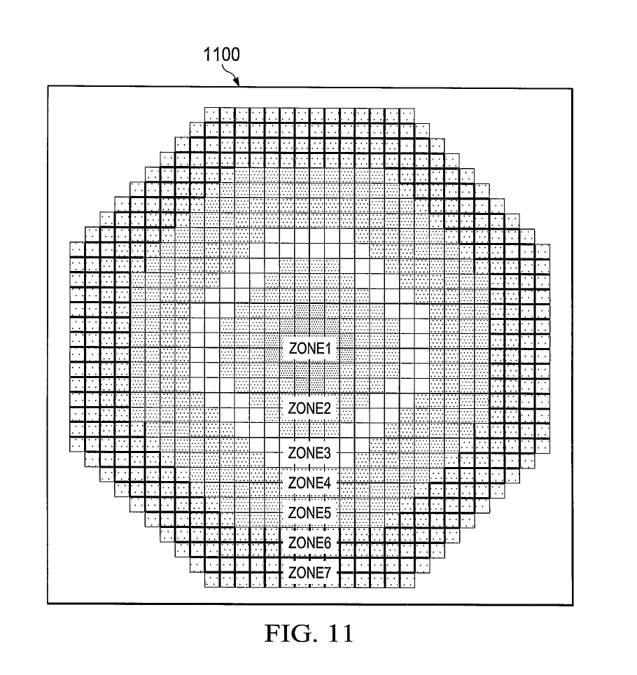

FIG. 11 illustrates example zones of a mixed-order CEFSS lens 1100 in accordance with this disclosure. In this illustrative example, the lens 1100 includes multiple zones, and each zone has a different amount of phase shift imparted on EM waves that radiate through that zone. As discussed above, the amount of phase shift of any one zone on the surface of the lens 1100 can be modified, manipulated, and/or tuned based on (i) the spacing and size of the patch metal elements in the respective zones and/or (ii) the order of the region of the lens. In some embodiments, outer zones of the lens 1100 may be in a third-order filter region, while inner zones of the lens 1100 may be in a fifth-order filter region.

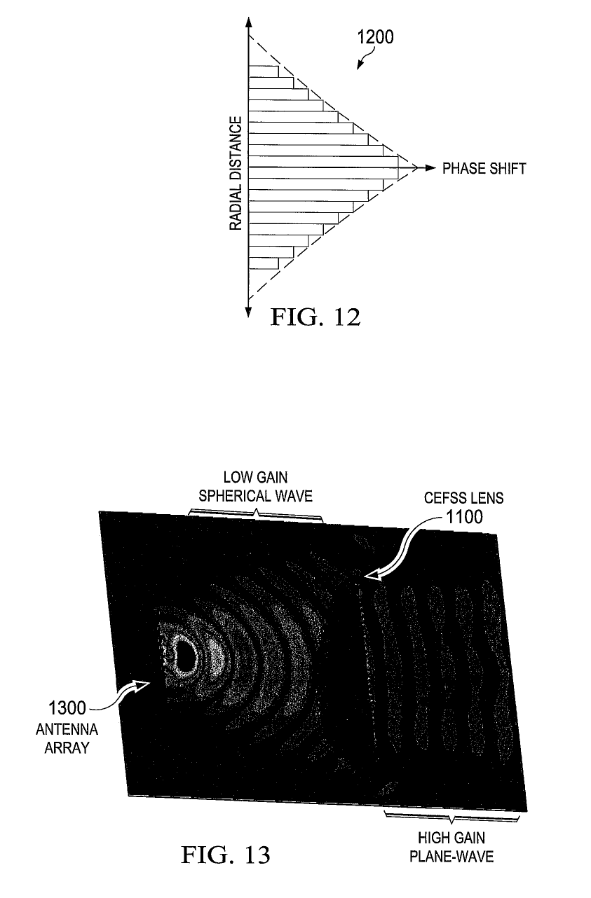

FIG. 12 illustrates an example spatial phase shift profile of the mixed-order CEFSS lens of this disclosure. In this illustrative example, the profile is depicted with a plot 1200 of phase shift versus radial distance from the center of a mixed-order CEFSS lens, such as the lens 1100 in FIG. 11. As depicted, the amount of phase shift increases near the center of the lens and decreases towards the outer edges of the lens.

FIG. 13 illustrates an example three-dimensional simulation of electromagnetic wave propagation through the mixed-order CEFSS lens 1100 in accordance with this disclosure. In this illustrative example, EM waves are propagated by an antenna array 1300 as spherical waves. As the EM waves propagate through the lens 1100, the phase shift tuning properties of the lens 1100 focus and/or collimate the EM waves into planar waves. The focusing and/or collimating by the lens 1100 also increases a gain of the EM waves.

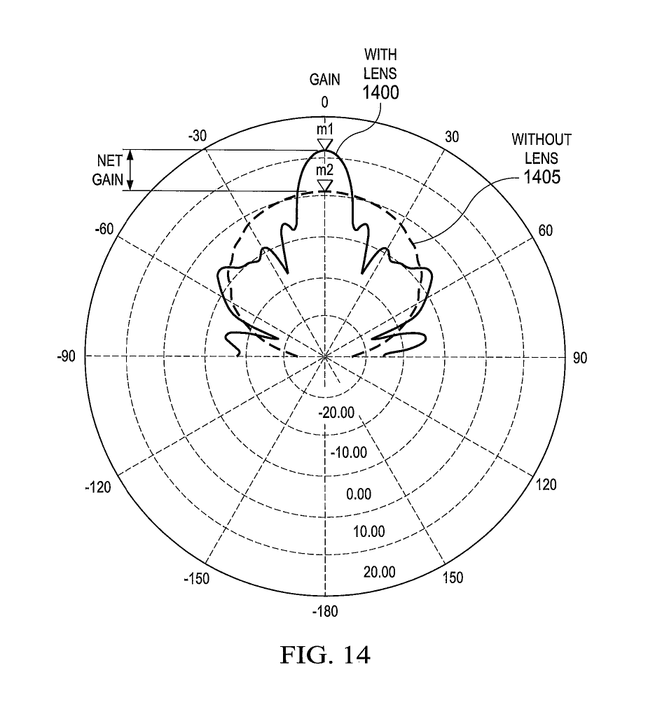

FIG. 14 illustrates an example plot of wave power gain versus angle of propagation for electromagnetic waves in accordance with this disclosure. In this illustrative example, a solid line 1400 depicts gain versus angle of propagation for EM waves transmitted through the lens 1100, while a dashed line 1405 depicts gain versus angle of propagation for EM waves transmitted without the lens 1100.

As illustrated, EM waves transmitted without the lens 1100 are spherical in that the waves have comparable gain in a wider range of propagation angles consistent with transmission from a point source, such as an antenna. On the other hand, for the EM waves transmitted through the lens 1100, the EM waves are focused with increased power gain around 0° of propagation, with lower gain at wider propagation angles. As depicted, the focusing and/or collimating of the EM waves by the lens 1100 can provide transmitting devices, such as a UE or eNB, with an increased ability to steer beams and to transmit at higher beam powers, which can lead to increased signal quality and/or ability to reduce/save transmission powers.

In various embodiments, the FSS lenses can enhance coverage of a beam steering angle. For example, an FSS lens may include spatial phase shifters that cause waves propagating through the lens to be focused in any desired angle. In other embodiments, the FSS lenses may be utilized for beam broadening. This beam broadening can provide different levels of beam widths in different angles of radiation, which can enable multi-functional wireless communication (such as antenna diversity).

While various embodiments above describe FSS lenses as being used in conjunction with a patch array antenna, the FSS lenses of this disclosure can be used with any type or shape of antennas, such as horn antennas, monopole antennas, dipole antennas, and slot antennas. Additionally, while the shape of the FSS lens is illustrated in some of the figures as being flat, the FSS lens may be a curved, non-flat, and/or conformal lens. Also, while the use of metal for the conductive patch elements has been described, the conductive patch elements could be fabricated from other conductive material(s). Additionally, while the shape of the conductive patch elements is illustrated in some of the figures as being rectangular or square, the conductive patch elements may have other shapes. For example, the conductive patch elements may be hexagons, ellipses, circles, octagons, shapes with curved as well as straight edges, etc. For this reason, the layers 610 can also be referred to as conductive element layers. Additionally, the FSS lenses of this disclosure can be designed and fabricated for applications involving nearly any RF frequency range, from a few megahertz to multiple hundreds of gigahertz (such as 1 MHz to 300 GHz). Moreover, the FSS lenses of this disclosure can be fabricated and integrated with various platforms without strict fabrication process requirements. For example, patterns in the FSS lenses of this disclosure may only be two dimensional without requiring vertical structures.

Embodiments of this disclosure provide several significant improvements to antennas for wireless communication systems and other applications. For example, the FSS lenses of this disclosure can provide increased antenna gains and directivities, reduced antenna pattern side-lobes, and reduced antenna losses. These technical improvements provide a host of commercial and market advantages to any products and systems using such lenses. For instance, the FSS lenses of this disclosure can provide higher data throughputs or higher data capacities. The higher antenna gains of antennas with lenses produce higher signal-to-noise ratio values, and higher signal-to-noise ratio values provide higher data throughputs and higher data capacities.

As another example, the FSS lenses of this disclosure can provide better connection availabilities and better connection establishments. The FSS lenses can provide higher gains and stronger signals, and stronger signal levels between eNBs and UEs (or between other devices) provide more dependable initial establishment of connection between the devices. The FSS lenses of this disclosure can also provide more reliable wireless connections due to higher directivities and higher interference suppressions of antennas with lenses. Higher directivities of beam steering provide alignment of antenna patterns with communication paths or channels. Higher directivities and lower side-lobes also reduce the level of undesired signals intercepted along a desired communication path. The FSS lenses of this disclosure can further provide lower densities of eNBs with a greater range of UEs. The higher antenna gains allow UEs to operate farther from their eNBs with comparable transmitter powers, allowing fewer eNBs within a given area.

As yet another example, the FSS lenses of this disclosure can provide longer battery life for mobile or consumer products. The enhanced gain of a mobile antenna allows a reduction in transmitter power for comparable signal level. The improved gain of an eNB antenna provides a reduction in the power required for the receiver at a UE. The enhanced gain can reduce the electrical power consumed in the UE's electronics and allow longer operations between battery recharge cycles. The FSS lenses of this disclosure can also provide smaller products or products with more features and functions. The enhanced antenna directivities or gains provided allow the area used by the antenna to be reduced. The extra area may be re-allocated for components needed for other system functions or features, or the extra area may be used to reduce the overall size and volume of a UE or eNB.

Embodiments of this disclosure also provide several design and construction advantages. Although planar lenses may be constructed in thin structures using conventional technologies (such as printed circuit boards), this often involves stringent tolerances. For millimeter and microwave frequencies, shapes and features in metal layers may need to be fabricated to accuracies and tolerances that exceed the capabilities of current fabrication technologies. This disclosure utilizes lens structures that allow for larger shapes and larger spacings between shapes in the metal layers of a lens while maintaining or increasing the capability of the lens to improve antenna performance. This increase in spacing allows relaxation of fabrication tolerances in the lens and provides a design method for practical construction of such lenses for antenna performance enhancements in commercial systems. Additionally, the FSS lenses of this disclosure may reduce the number of both metal and dielectric layers used, which can simplify lens design and construction; reduce the lens cost, thickness (size), and weight; and reduce or eliminate extraneous materials in lens construction that may degrade performance.

Although this disclosure has been described with an example embodiment, various changes and modifications may be suggested to one skilled in the art. It is intended that this disclosure encompass such changes and modifications as fall within the scope of the appended claims.

What is claimed is:

1. An apparatus comprising:
a lens comprising a plurality of layers of conductive elements and a plurality of layers of dielectric,
each of the layers of dielectric disposed between and in contact with two of the layers of conductive elements.

2. The apparatus of claim 1, wherein different layers of conductive elements include different numbers of conductive elements.

3. The apparatus of claim 2, wherein a number of conductive elements varies across a thickness of the lens.

4. The apparatus of claim 2, wherein:
each layer of conductive elements includes elements arranged in rows and columns, and
at least one of the layers of conductive elements has fewer rows and fewer columns than at least another of the layers of conductive elements.

5. The apparatus of claim 1, wherein:
an operating frequency for spatial phase shifting is based on capacitive coupling between conductive elements on opposite sides of one of the layers of dielectric; and
the capacitive coupling is based on a thickness of the one of the layers of dielectric.

6. The apparatus of claim 1, wherein the layers of conductive elements and the layers of dielectric form a Cauer/Elliptic frequency selective surface.

7. The apparatus of claim 1, wherein the lens includes only three layers of conductive elements and only two layers of dielectric.

8. The apparatus of claim 7, wherein the lens is a mixed-order frequency selective surface with a middle layer of conductive elements having fewer conductive elements than outer layers of conductive elements.

9. The apparatus of claim 1, wherein a size of the conductive elements in at least one of the layers of conductive elements varies as distance from a center of the lens increases.

10. The apparatus of claim 1, wherein a lateral dimension of the conductive element and a thickness of the lens are less than a wavelength of an operating frequency for spatial phase shifting.

11. A method comprising:
transmitting an electromagnetic wave through a lens comprising a plurality of layers of conductive elements and a plurality of layers of dielectric, each of the layers of dielectric disposed between and in contact with two of the layers of conductive elements.

12. The method of claim 11, wherein different layers of conductive elements include different numbers of conductive elements.

13. The method of claim 12, wherein a number of conductive elements varies across a thickness of the lens.

14. The method of claim 12, wherein:
each layer of conductive elements includes elements arranged in rows and columns, and
at least one of the layers of conductive elements has fewer rows and fewer columns than at least another of the layers of conductive elements.

15. The method of claim 11, wherein:
an operating frequency for spatial phase shifting is based on capacitive coupling between conductive elements on opposite sides of one of the layers of dielectric; and
the capacitive coupling is based on a thickness of the one of the layers of dielectric.

16. The method of claim 11, wherein the layers of conductive elements and the layers of dielectric form a Cauer/Elliptic frequency selective surface.

17. A system comprising:
a lens;
a transmitter or transceiver configured to generate or receive signals for wireless transmission; and
an antenna configured to transmit or receive electromagnetic waves through the lens based on the signals;
wherein the lens comprises a plurality of layers of conductive elements and a plurality of layers of dielectric, each of the layers of dielectric disposed between and in contact with two of the layers of conductive elements.

18. The system of claim 17, wherein different layers of conductive elements include different numbers of conductive elements.

19. The system of claim 18, wherein the transmitter or transceiver, antenna, and lens form part of a user equipment.

20. The system of claim 18, wherein multiple transmitters or transceivers, multiple antennas, and multiple lenses form part of an eNodeB.
